(19) United States
(12) Patent Application Publication
(10) Pub. No.: US 2007/0128474 A1
(43) Pub. Date: Jun. 7, 2007

(54) SHUTDOWN PROCEDURE FOR FUEL CELL STACKS

(76) Inventors: Peter J. Bach, Vancouver (CA); Mark K. Watson, Langley (CA); Craig R. Louie, West Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/560,720

(22) Filed: Nov. 16, 2006

Related U.S. Application Data
(60) Provisional application No. 60/737,932, filed on Nov. 18, 2005.

(51) Int. Cl. H01M 8/00

(52) U.S. Cl. 429/13

(57) ABSTRACT

A method of ceasing operation of a fuel cell stack, the fuel cell stack comprising a plurality of fuel cells, each fuel cell comprising at least one anode flow field and at least one cathode flow field for supplying fuel and oxidant thereto, the fuel comprising hydrogen, the method comprising the steps of disconnecting a primary load from the fuel cell stack; terminating the supply of oxidant to the disconnected fuel cell stack; terminating the supply of fuel to the disconnected fuel cell stack; recirculating the fuel through the at least one anode flow field of each fuel cell until all of the oxygen in the oxidant is substantially consumed; and maintaining a hydrogen depletion rate of less than about 3.0% hydrogen/° C. decrease in a fuel cell stack temperature as the fuel cell stack cools down to a predetermined temperature.

### CROSS-REFERENCE TO RELATED APPLICATION

This application claims the benefit under 35 U.S.C. § 119(e) of U.S. Provisional Patent Application No. 60/737,932 filed Nov. 18, 2005, which provisional application is incorporated herein by reference in its entirety.

### BACKGROUND OF THE INVENTION

1. Field of the Invention

The present invention relates to fuel cell stacks, and more specifically, to methods of ceasing operation of a fuel cell stack.

2. Description of the Related Art

Electrochemical fuel cells convert fuel and oxidant into electricity. Solid polymer electrochemical fuel cells generally employ a membrane electrode assembly which includes an ion exchange membrane or solid polymer electrolyte disposed between two electrodes typically comprising a layer of porous, electrically conductive sheet material, such as carbon fiber paper or carbon cloth. The membrane electrode assembly comprises a layer of catalyst, typically in the form of finely comminuted platinum, at each membrane electrode interface to induce the desired electrochemical reaction. In operation, the electrodes are electrically coupled for conducting electrons between the electrodes through an external circuit. Typically, a number of membrane electrode assemblies are electrically coupled in series to form a fuel cell stack having a desired power output.

The membrane electrode assembly is typically interposed between two electrically conductive flow field plates, or separator plates, to form a fuel cell. Such flow field plates comprise flow fields to direct the flow of the fuel and oxidant reactant fluids to the anode and cathode electrodes of the membrane electrode assemblies, respectively, and to remove excess reactant fluids and reaction products, such as water formed during fuel cell operation.

It is well known that when ceasing operation of a fuel cell stack with uncontrolled methods, undesirable anode and cathode half-cell potentials may result in at least a portion of the fuel cells in the fuel cell stack, leading to oxidation and degradation of at least some of the fuel cell components. Thus, it is desirable to develop methods for ceasing operation of a fuel cell stack so that undesirable anode and cathode half-cell potentials are minimized. The present invention addresses these issues and provides further related advantages.

### BRIEF SUMMARY OF THE INVENTION

In brief, the present invention relates to a method of ceasing operation of a fuel cell stack, the fuel cell stack comprising a plurality of fuel cells, each fuel cell comprising at least one anode flow field and at least one cathode flow field for permitting the flow of fuel reactant fluid and air reactant fluid through the at least one anode flow field and the at least one cathode flow field, respectively, the method comprising the step of maintaining a rate of hydrogen depletion of less than about 3.0% hydrogen/° C. decrease in a fuel cell stack temperature as the fuel cell stack cools down to a predetermined temperature.

In one embodiment, the method comprises the steps of disconnecting a primary load to the fuel cell stack, terminating the supply of oxidant and fuel to the fuel cell stack, recirculating a flow of fuel until oxygen in the oxidant is substantially consumed, and then maintaining a rate of hydrogen depletion of less than about 3.0% hydrogen/° C. decrease in a fuel cell stack temperature from at least a portion of at least one anode flow field of each fuel cell, as the fuel cell stack cools down to a predetermined temperature.

In another embodiment, the method comprises the steps of disconnecting a primary load to the fuel cell stack, terminating the supply of oxidant to the fuel cell stack, supplying fuel to the fuel cell stack until oxygen in the oxidant is substantially consumed, terminating the supply of fuel to the fuel cell stack, and then maintaining a rate of hydrogen depletion of less than about 3.0% hydrogen/° C. decrease in a fuel cell stack temperature from at least a portion of at least one anode flow field of each fuel cell, as the fuel cell stack cools down to a predetermined temperature.

These and other aspects of the invention will be evident upon review of the attached drawings and following detailed description.

### BRIEF DESCRIPTION OF THE DRAWINGS

In the figures, identical reference numbers identify similar elements or acts. The sizes and relative positions of elements in the figures are not necessarily drawn to scale. For example, the shapes of various elements and angles are not drawn to scale, and some of these elements are arbitrarily enlarged and positioned to improve figure legibility. Further, the particular shapes of the elements, as drawn, are not intended to convey any information regarding the actual shape of the particular elements, and have been solely selected for ease of recognition in the figures.

FIG. 1 shows a simplified fuel cell system.

FIG. 2 shows a fuel cell of the simplified fuel cell system.

### DETAILED DESCRIPTION OF THE INVENTION

Unless the context requires otherwise, throughout the specification and claims which follow, the word “comprise” and variations thereof, such as “comprises” and “comprising” are to be construed in an open, inclusive sense, that is as “including but not limited to”.

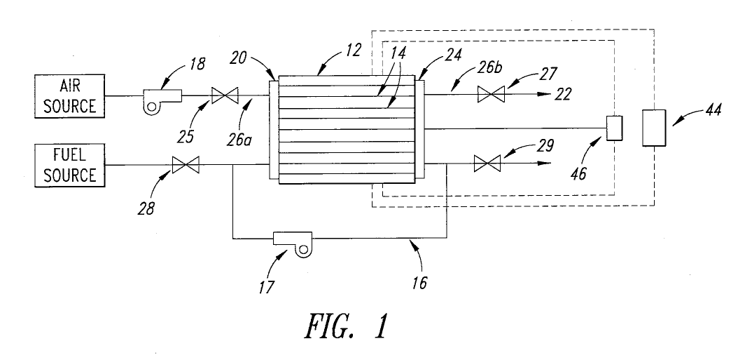

FIG. 1 shows a simplified fuel cell system 10 having a plurality of fuel cells 14, an anode recirculation loop 16, an anode recirculation pump 17, an air compressor 18 upstream of a fuel cell stack inlet 20, an oxidant exit 22 downstream of a fuel cell stack outlet 24, an oxidant inlet 26a for delivering oxidant to fuel cell stack inlet 20, an oxidant outlet 26b for removing product fluids from fuel cell stack outlet 24, and an oxidant inlet valve 25 and a fuel inlet valve 28 upstream of fuel cell stack inlet 20. Optionally, fuel cell system 10 may also comprise an air outlet valve 27 and a fuel outlet valve 29 downstream of fuel cell stack outlet 24.

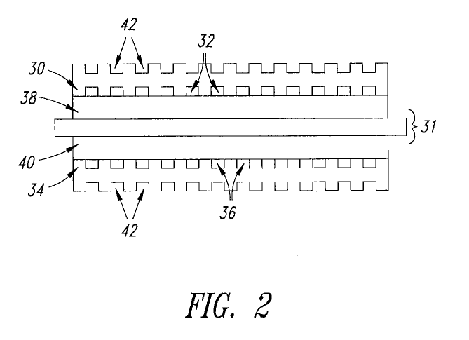

FIG. 2 shows an exemplary fuel cell of fuel cell stack 12. Fuel cell 14 comprises a membrane electrode assembly 31 (hereinafter referred to as MEA) disposed between an anode flow field plate 30 and a cathode flow field plate 34. Anode flow field plate 30 includes anode flow fields 32 on a first surface for directing the flow of fuel through fuel cell 14 and, similarly, cathode flow field plate 34 includes cathode flow fields 36 on a first surface for directing the flow of oxidant through fuel cell 14. When assembled into a fuel cell, anode flow fields 32 of anode flow field plate 30 faces anode electrode 38 of fuel cell 14 and, similarly, cathode flow fields 36 of cathode flow field plate 34 faces cathode electrode 40 of fuel cell 14. An opposing second surface of anode flow field plate 30 and cathode flow field plate 34 may further comprise coolant fields 42 for circulating a coolant through fuel cell 14. Alternatively, only one of anode flow field plate 30 or cathode flow field plate 34 comprises coolant flow fields 42 on its second surface. A plurality of fuel cells 14 are then stacked together such that coolant flow fields 42 (or the second surface) of anode flow field plate 30 of one fuel cell contacts coolant flow fields 42 (or the second surface) of cathode flow field plate 34 of an adjacent fuel cell.

In one embodiment, and referring to FIG. 1, when ceasing operation of the fuel cell stack, a primary load 44 is first disconnected from fuel cell stack 12 and the supply of oxidant and fuel to fuel cell stack 12 terminated (e.g., the oxidant is typically air). Residual fuel in fuel cell stack 12 is then recirculated through fuel cell stack 12 and anode recirculation loop 16 for a period of time to substantially consume all of the residual oxygen in the oxidant residing in each fuel cell 14, oxidant inlet 26a and oxidant outlet 26b. Oxidant inlet valve 25 and fuel inlet valve 28 may be closed during this time and throughout the shutdown period of fuel cell system 10 to prevent leakage of oxidant into fuel cell stack 12, anode recirculation loop 16, oxidant inlet 26a, and oxidant outlet 26b.

After substantial consumption of the residual oxygen in fuel cell stack 12 and oxidant pipes 26, fuel cell stack 12 is then cooled down to a predetermined temperature. This occurs due to the difference between the ambient air temperature and the temperature of fuel cell stack 12 immediately after substantial consumption of the residual oxygen, which should be approximately the same as its operating temperature. For example, the operating temperature of most solid polymer fuel cells may range from about 60° C. to about 120° C. However, after substantial consumption of the residual oxygen in fuel cell stack 12, oxidant inlet 26a and oxidant outlet 26b, oxidant may slowly leak into fuel cell stack 12, anode recirculation loop 16, oxidant inlet 26a and oxidant outlet 26b during cooldown of fuel cell stack 12. This will consume the hydrogen residing in fuel cell stack 12 and anode recirculation loop 16, and may result in unacceptable anode and cathode half-cell potentials in at least a portion of fuel cells 14 of fuel cell stack 12 when the fuel cell stack is restarted.

However, if the rate of hydrogen depletion in at least a portion of anode flow field plates 30 of fuel cell stack 12 is less than about 3.0% hydrogen/° C. decrease in the fuel cell stack temperature as the fuel cell stack cools down, fuel cells 14 of fuel cell stack 12 will not substantially experience unacceptable anode and cathode half-cell potentials when the fuel cell stack is restarted. When the fuel cell stack decreases to a predetermined temperature, the rate of hydrogen depletion does not need to be maintained any further. Without being bound by theory, at temperatures at or below the predetermined temperature, the activation energy for corrosion and oxidation is very high and, thus, corrosion and oxidation of the carbonaceous components does not substantially occur even if the anode and cathode half-cell potentials are at unacceptable levels.

In another embodiment, after disconnection of primary load 44, the supply of oxidant to fuel cell stack 12 is terminated. Fuel is continually supplied to fuel cell stack 12 until all of the residual oxygen in the oxidant residing in each fuel cell 14, oxidant inlet 26a and oxidant outlet 26b is consumed. The supply of fuel is then terminated and fuel cell stack 12 is then cooled down to a predetermined temperature such that the rate of hydrogen depletion in at least a portion of anode flow field plates 30 of fuel cell stack 12 and anode recirculation loop 16 is less than about 3.0% hydrogen/° C. decrease in the fuel cell stack temperature.

In further embodiments, the fuel may be pressurized in fuel cell stack 12 and anode recirculation loop 16 before or after disconnection of the primary load. This increases the amount of hydrogen residing in fuel cell stack 12 and anode recirculation loop 16. One of ordinary skill in the art will recognize that the fuel should not be pressurized so much as to induce undesirable pressure differentials between the fuel and the air residing in fuel cell stack 12 because it may damage the ion exchange membrane of each fuel cell 14.

In yet other embodiments, and again referring to FIG. 1, an auxiliary load 46 may be connected to fuel cell stack 12 to increase the rate of oxygen consumption as fuel is supplied to and/or recirculated through fuel cell stack 12 and anode recirculation loop 16.

In any of the above-described embodiments, the total volume of the anode loop and the total volume of the cathode loop may be selected such that the molar ratio of hydrogen residing in the anode loop and oxygen residing in the cathode loop is at least 2.1:1. The total volume of the anode loop and the total volume of the cathode loop should be selected in order to maintain the desired rate of hydrogen depletion until the stack reaches the predetermined temperature. In FIG. 1, the total volume of the anode loop is the sum of the volume of fuel residing in anode recirculation loop 16 and the cumulative volume of the at least one anode flow field of each fuel cell of fuel cell stack 12. Similarly, the total volume of the cathode loop is the sum of the volume of oxidant residing in oxidant pipes 26 and the cumulative volume of oxidant residing in the cathode flow fields of each fuel cell of fuel cell stack 12. Alternatively or in combination, a hydrogen reservoir may be placed in fluid communication with anode recirculation loop 16, which maximizes the volume of anode recirculation loop 16.

In any of the above-described embodiments, the rate of oxidant diffusion into fuel cell stack 12 may be selected to ensure that the rate of hydrogen depletion in at least a portion of anode flow field plates 30 of fuel cell stack 12 and anode recirculation loop 16 is less than about 3.0% hydrogen/° C. decrease in the fuel cell stack temperature. In one embodiment, the distance of oxidant inlet 26a and oxidant outlet 26b is maximized. This can be achieved by, alternatively or in combination, decreasing the cross-sectional area of oxidant inlet 26a and oxidant outlet 26b, increasing the distance between air compressor 18 and fuel cell stack inlet 20, and/or increasing the distance between air exit 22 and fuel cell stack outlet 24.

In yet further embodiments, coolant may be circulated through fuel cell stack 12 to enhance the cooldown rate of fuel cell stack 12 at any time during or after oxygen consumption to ensure that the rate of hydrogen depletion is within the desired range. Alternatively or in combination, fuel cell stack 12 may comprise additional cooling means to enhance the cool down rate of fuel cell stack 12, such as adding cooling fins to the outside surfaces of fuel cell stack 12 and/or fuel cell system 10 (not shown). This further enhances the cooldown rate of fuel cell stack 12 without needing to consume additional parasitic power.

In any of the above-described embodiments, when the temperature of fuel cell stack 12 decreases to a predetermined temperature, the rate of hydrogen depletion does not need to be maintained any further, as explained previously. For example, when fuel cell stack 12 reaches the predetermined temperature of about, for example, 35° C., shutdown of fuel cell system 10 is complete.

While particular elements, embodiments, and applications of the present invention have been shown and described, it will be understood that the invention is not limited thereto since modifications may be made by those skilled in the art without departing from the spirit and scope of the present disclosure, particularly in light of the foregoing teachings.

What is claimed is:

1. A method of ceasing operation of a fuel cell stack, the fuel cell stack comprising a plurality of fuel cells, each fuel cell comprising at least one anode flow field and at least one cathode flow field for supplying fuel and oxidant thereto, the fuel comprising hydrogen, the method comprising the steps of:
disconnecting a primary load from the fuel cell stack;
terminating the supply of oxidant to the disconnected fuel cell stack;
terminating the supply of fuel to the disconnected fuel cell stack;
recirculating the fuel through the at least one anode flow field of each fuel cell until all of the oxygen in the oxidant is substantially consumed; and
maintaining a hydrogen depletion rate of less than about 3.0% hydrogen/° C. decrease in a fuel cell stack temperature as the fuel cell stack cools down to a predetermined temperature.

2. The method of claim 1 further comprising the step of pressurizing the fuel prior to terminating the supply of fuel to the disconnected fuel cell stack.

3. The method of claim 1 further comprising the step of connecting an auxiliary load to the disconnected fuel cell stack after terminating the supply of oxidant.

4. The method of claim 1 further comprising the step of circulating a coolant through at least one coolant flow field of the fuel stack for a predetermined duration of time as the fuel cell stack cools down to the predetermined temperature.

5. The method of claim 1 wherein the predetermined temperature is about 35° C.
